(19) United States
(12) Patent Application Publication
(10) Pub. No.: US 2021/0279826 A1
(43) Pub. Date: Sep. 9, 2021

(54) METHOD AND SYSTEM FOR PROPERTY TITLE EXCHANGE

(71) Applicant: AUSTRALIAN TITLE EXCHANGE PTY LTD, Kellyville, New South Wales (AU)

(72) Inventors: Anthony Josef KAELIN, Cammeray (AU); Anthony Daniel STONE, Cammeray (AU)

(21) Appl. No.: 16/328,280

(22) PCT Filed: Aug. 25, 2017
(86) PCT No.: PCT/AU2017/050906

§ 371 Date: Feb. 25, 2019

(30) Foreign Application Priority Data
Aug. 26, 2016 (AU) 2016903406
May 17, 2017 (AU) 2017901851

(51) Int. Cl. G06Q 50/16; G06Q 40/04; G06Q 10/10; G06Q 50/18; G06Q 30/06; G06Q 20/12; G06Q 30/02

(52) U.S. Cl. CPC G06Q 50/167; G06Q 40/04; G06Q 10/10; G06Q 30/0278; G06Q 30/0645; G06Q 20/127; G06Q 50/18

(57) ABSTRACT

Disclosed herein are a property trading method and system. The method includes the steps of: receiving initial property information regarding a property; determining an initial property valuation for said property, based on said initial property information; converting said property to a set of securities and related derivative instruments; and listing said set of securities and related derivative instruments for trading on a property trading platform.

### RELATED APPLICATION

The present application is related to Australian Provisional Patent Application No. 2016903406 titled “Method and system for property title exchange” and filed 26 Aug. 2016 in the name of Australian Title Exchange Pty Ltd, and Australian Provisional Patent Application No. 2017901851 titled “Method and system for property title exchange” and filed 17 May 2017 in the name of Australian Title Exchange Pty Ltd, the entire content of which is incorporated by reference, as if fully set forth herein.

### TECHNICAL FIELD

The present disclosure relates to a method and system for property title exchange.

### BACKGROUND

Various systems and platforms are known to enable trading in publicly listed companies and commodities. In such systems, portions or quantities (i.e., shares) of a product are offered for sale and bids are placed by prospective purchasers. When agreement is reached between the vendor and the purchaser, a trade occurs.

Many people trade in publicly listed shares and commodities either directly or through various managed funds. Managed funds are provided by private investment companies that aggregate funds from individual investors and invest across different classes of investments in attempts to maximise profits whilst providing resilience through diversification. Superannuation funds are examples of managed funds.

There is a large amount of money invested in private land holdings. In particular, it is common in many places for people to pay a substantial amount of their wage to pay mortgages on purchased residential properties. This results in a large amount of capital being dedicated to home purchases and unavailable for other use.

Over time, many residential properties appreciate in value. While banks and other financial institutions provide various facilities to enable a home owner to borrow money on the basis of equity owned in a residential property, relatively few people are able to service the subsequent debt or tolerate the often onerous terms set by the respective banks or financial institutions.

Additionally, the rate of capital appreciation of real estate, particularly that of residential properties, continues to adversely affect housing affordability and in some areas has placed home ownership well out of reach of many home seekers.

Further, existing home owners or mortgagees who encounter financial difficulty often have few options other than to sell the home in its entirety. Selling the home entirely results in the former home owner or mortgagee being homeless, and forcing them to relocate to a less suitable property as well as reincurring debt and establishment costs, or take on a rental lease and likely forgo the opportunity of future home ownership.

The existing paradigm presents a substantial barrier to home ownership and to the financial liquidity of home owners

Thus, a need exists to provide an improved method and system to lower the barrier to home ownership as well as enabling existing property owners to leverage equity owned in their property.

### SUMMARY

The present disclosure relates to a networked computer system and associated method for generating and trading in property-based equity securities.

A first aspect of the present disclosure provides a property trading method comprising the steps of:

receiving initial property information regarding a property;

determining an initial property valuation for said property, based on said initial property information;

converting said property to a set of securities and related derivative instruments; and

listing said set of securities and related derivative instruments for trading on a property trading platform.

A second aspect of the present disclosure provides a system for facilitating the sale of a portion of a property, the system including:

a database for storing property data relating to at least one property offered for conversion to shares and trading data relating to past property share trading activities, wherein each property is associated with a set of ordinary shares and related derivative instruments;

a trading platform adapted to provide an exchange for trading of shares and derivative instruments in said at least one property, based on said received trading requests; and

a computer server adapted to host a website associated with said trading platform, said website providing a user interface to receive trading requests in relation to said shares and derivative instruments.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIGS. 1A and 1B are schematic representations illustrating flow of information through a property trading platform;

FIGS. 1C and 1D are schematic representations illustrating flow of information through a property trading platform;

FIG. 2A is a schematic representation of a method of property trading;

FIG. 2B is a schematic representation of a method of property trading;

FIG. 3 is a flow diagram of an onboarding phase of a method of property trading;

FIG. 4A is a flow diagram of a conversion phase of a method of property trading;

FIG. 4B is a flow diagram of a conversion phase of a method of property trading;

FIG. 5A is a flow diagram of a trading phase of a method of property trading;

FIG. 5B is a flow diagram of a trading phase of a method of property trading;

FIG. 6A is a flow diagram of a maintenance phase of a method of property trading;

FIG. 6B is a flow diagram of a maintenance phase of a method of property trading suitable for use with derivatives and Title Lease Contracts;

FIG. 7A is a flow diagram of a market data phase of a method of property trading;

FIG. 7B is a flow diagram of a market data phase of a method of property trading;

FIG. 8 is a schematic representation of a system on which one or more embodiments of the present disclosure may be practised;

FIG. 9 is a schematic block diagram representation of a system that includes a general purpose computer on which one or more embodiments of the present disclosure may be practised; and

FIG. 10 is a schematic block diagram representation of a system that includes a general smartphone on which one or more embodiments of the present disclosure may be practised.

### DETAILED DESCRIPTION

Method steps or features in the accompanying drawings that have the same reference numerals are to be considered to have the same function(s) or operation(s), unless the contrary intention is expressed or implied.

The present disclosure provides a property trading system implemented by a networked computer system and an associated method. The property trading system may be referred to herein as the APTEX system. The property trading system enables trading in equity securities derived from properties. In particular, one or more aspects of the present disclosure provide a property trading system implemented by a networked computer system incorporating computer program code and databases that enable the conversion of property to equity securities, the marketing of those equity securities, and ongoing management and trading of the equity securities.

In one arrangement, the property trading system is extended such that the computer program codes and databases of the system further enable conversion of property to equity securities and related derivative instruments. In such an arrangement, the property trading system enables marketing of the derivatives and ongoing management and trading of the derivatives.

In association with the above-noted property trading system, the present disclosure also provides a networked computer system incorporating computer program code that when executed on one or more processors of computing devices within the system enable generation, analysis, and dissemination of market indices, market data, and participant data relating to the property trading system.

The property trading system includes an operating equity securities exchange and market system, where each property entity is listed individually. Investors are able to trade in securities of those listed entities. Investors are able to trade directly in the securities of individually listed property entities, as well as security products made of grouped property entities.

In one arrangement, the property trading system optionally includes an operating derivatives exchange and market system, where derivatives may be traded. Such derivatives may include, for example, but are not limited to, lease contracts and discounted share options. The derivatives exchange and market system provides a marketplace in the form of a computer-implemented platform through which lease contract holders and investors are able to trade directly in those derivatives.

The property trading system of the present disclosure also includes networked computer systems, developed software and databases which achieve generation, analysis and dissemination of resulting equity market indices, market data, and participant data.

The property trading system in accordance with the present disclosure is capable of storing large data sets and performing calculations in relation to dividends and lease payments associated with trading in equity securities derived from properties. Such calculations may require large amounts of data to be processed at periodic intervals, such as daily, weekly, monthly, quarterly, or annually, in order to determine dividends and lease payments. Further, the results of such periodic calculations may need to be stored for later use in further calculations and for auditing purposes. The computer-implemented property trading system thus provides a technical platform through which to effect trading transactions and also addresses a technical problem of managing onerous and cumbersome administrative tasks relating to trading transactions.

In accordance with a method of the present disclosure, a property owner is able to offer a property that they own for conversion to equity securities (i.e., shares). Shares in the property are then marketed as being publicly available for sale and may be purchased by one or more interested purchasers. The property shares may subsequently be traded at agreed prices reflecting the current market value of the property.

The property trading system of the present disclosure receives information from a participating property owner regarding a property that is to be converted to securities for trading. The system formulates and executes the validation, valuation, securities configuration, marketing and sale of the securities.

In one arrangement, securities in a property that has been converted for trading are transformed and listed as two distinct types: ordinary and preferential. Ordinary securities may be bought and sold through the platform. Preferential securities assign the exclusive rights to access and occupy the subject property, let the subject property, as well as perform improvements to the subject property. These preferential securities can be perpetually traded, but may only ever be traded in predefined block sizes. The block sizes may differ from one property to another. Further, preferential securities associated with a subject property may be broken into equal block sizes or unequal block sizes. The property owner is given the option either to market and sell some or all of the preferential securities or, alternatively, retain some or all of the preferential securities.

In one example, an owner of an apartment block comprising four apartments over two levels wishes to convert her property for trading. In this example, the apartment block as a whole is converted into ordinary and preferential shares, with the preferential shares to be offered in four blocks, corresponding to the four apartments. The block sizes of the preferential shares may differ to reflect the location, size, advantages, and disadvantages of the respective apartments. In one scenario, the owner chooses to retain the preferential securities corresponding to two apartments on the top floor and offers for sale the preferential securities corresponding to the two ground floor apartments. A purchaser of the preferential shares corresponding to one of the ground floor apartments acquires the right to access and occupy that apartment. Depending on the implementation, the terms of the preferential share purchase may govern the terms and conditions for future trading or leasing of those preferential shares and the purpose to which the corresponding apartment may be put.

In another arrangement, securities in a property that has been converted for trading are transformed and listed entirely as ordinary securities. At the time of conversion, the property management system generates a Title Lease Contract (TLC) for the subject property. The TLC is a perpetually renewable lease and assigns the exclusive rights to access and occupy the subject property, let the subject property, as well as perform improvements to the subject property. The holder of the TLC will make agreed lease payments through the platform. The proceeds from the lease payments are then distributed through the platform as dividends to owners of ordinary securities of the respective property.

In one arrangement, the lease payments are prorated based on the amount of equity (i.e., the proportion of shares) held by the lessee. For example, a person holing 25% of shares in a property to which the person holds the TLC will need to pay lease payments corresponding to 75% of the agreed lease payment. That is, the actual lease payments are offset by the 25% shareholding of the lessee. Depending on the implementation, the lease payments may be calculated periodically against the relative share holdings, wherein the period of calculation may include, but is not limited to, daily, weekly, fortnightly, monthly, quarterly, or annually. Depending on the implementation, weightings may be applied to the amount of equity held when calculating the lease payments. Such weightings may be applied in a linear manner, a stepped manner, or the like. For example, equity holdings in the order of less than 5% may be multiplied by a weighting of 1.0, equity holdings in the range between 5% and 20% may be multiplied by a weighting of 1.5, and equity holdings of 20% or more may be multiplied by a weighting of 2.0. The actual weightings and ranges will depend on the particular implementation.

Further arrangements may calculate the lease payments based on one or more other considerations, including or excluding the involvement of amount of equity held, as described above. Such other considerations may include, for example, but are not limited to, a trade volume of equities for the respective property within a defined period, a rate of price variation of one or more equity holdings during a defined period, or a combination thereof.

In one arrangement, dividends distributed through the platform to owners of ordinary shares are calculated based on the period of investment by the respective owners. That is, a shareholder receives a dividend on their shares for the period of time for which the shares have been held. Consequently, shares in a property will always be associated with a dividend corresponding to the period of time those shares are held by a particular owner. In one implementation, the dividends associated with a shareholding accrue in real-time and are paid periodically.

In one arrangement, the property owner is provided the option to market and sell the TLC at the time of conversion, or retain and exercise the contract. The TLC will also be separately listed as a tradable instrument which can be bought and sold through the platform.

In one arrangement, the property trading system includes a TLC processor and a reporting processor. The TLC processor compiles relevant pricing and conditional data from a market analysis data module and a reporting processor, described below. Based on the relevant pricing and conditional data, the TLC processor generates an initial TLC.

In one arrangement, holders of Title Lease Contracts who own qualifying levels of equity securities within a property are periodically offered discounted share options within that property. The offeree has the opportunity to exercise the options or further trade those options through the platform. In one arrangement, the qualifying levels of equity securities within a property are defined by the platform. In one arrangement, the discounted share options are offered at predefined periodic intervals, such as quarterly, half-yearly, annually, or biennially, for example. It will be appreciated that other periodic intervals may be used, and such intervals may be user-defined or defined by an administrator of the system.

In one arrangement, the qualifying levels of equity securities are predefined strata, based on a value of the property to be converted. For example, a first person holding 5% equity securities within a property may be offered a first level of share options within that property, whereas a second person holding 11% is offered a second level of share options within that property, based on predefined qualifying strata of 5%-9.9%, 10% to 14.9%, and greater than or equal to 15%. Such strata encourage holders of equity securities in a property to invest further in that property. In another arrangement, the qualifying levels of equity securities correspond to predefined percentages of the value of the property to be converted. In an alternative arrangement, a linear progression is used, such that the level of share options offered to a holder of equity securities is directly proportional to the percentage of equity securities held by that person. It will be appreciated that many variants of qualifying levels may be practised without departing from the spirit and scope of the present disclosure.

Participating investors access the property trading system to analyse, trade and track the listed real estate converted securities, along with any associated TLCs. Investors can include, for example, private, institutional, or agent entities.

The property trading system optionally provides one or more indices, as well as live and historical securities data and analysis. Such indices, data, and analysis may be offered to consumers of market data. Consumers of personal data can access the property trading system to access ownership, activity and rating data for market participants. Browsing users, which may include existing holders of equity securities or prospective purchasers, can view and analyse data relating to properties listed on the platform, along with associated terms and conditions associated with related TLCs and any associated discounted share plans.

The property trading system enables property owners to realise equity without incurring debt. Prospective home buyers who are unable to afford to purchase a whole property can purchase shares in one or more properties. Prospective home buyers can also purchase a property and then convert the property to tradeable securities in order to subsidise the purchase. Consequently, the property trading platform lowers the entry point for home buyers and property investors.

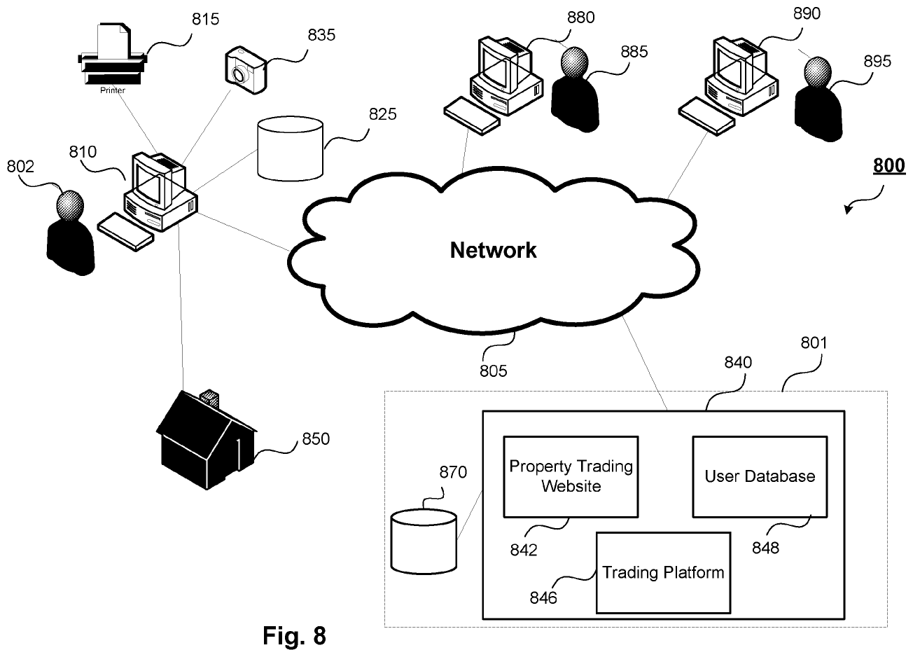

FIG. 8 is a schematic representation of a networked computer system 800 on which one or more embodiments of the present disclosure may be practised. The system 800 includes a property trading system 801 coupled to a communications network 805. The communications network 805 may include, for example, one or more wired or wireless connections, including a Local Area Network (LAN), Wide Area Network (WAN), a virtual private network (VPN), cellular telephony network, the Internet, or any combination thereof.

The property trading system 801 is used to implement a property trading platform. The property trading system 801 includes a server 840 that hosts a Property Trading Website 842, a user database 848, and a trading platform 846. The server 840 is also coupled to a database 870, which may be internal or external to the server 840. The database 870 stores data relating to properties for conversion to shares and data relating to past property share trading activities.

The system 800 also includes a first computing device 810 coupled to the communications network 805. The first computing device 810 may be implemented using a smartphone, laptop, desktop computer, server, or general purpose computer. The first computing device 810 in the example of FIG. 8 is coupled to a printer 815, a camera 835, and a database 825. The camera 835 may be utilised, for example, to capture images relating to a property that is to be offered for conversion to shares.

A user 802 owns a property 850, which in this example is a residential property that includes a house. It will be appreciated by a person skilled in the art that any form of real estate may be converted to shares within the spirit and scope of the present disclosure, including, but not limited to, residential properties, commercial properties, rural properties, land only packages, and the like. The user 802 accesses the computing device 810 to communicate, via the communications network 805, with the Property Trading Website 842 hosted on the server 801. The Property Trading Website 842 sends content to the first computing device 810 for display via a user interface on a display device of the computing device 810. The user interface guides the user 802 through various phases of the property trading process.

The system 800 also includes second and third computing devices 880 and 890, each of which is coupled to the communications network 805. The second and third computing devices 880, 890 are accessed by traders 885, 895, respectively, wanting to trade in equity securities managed by the property trading platform 801.

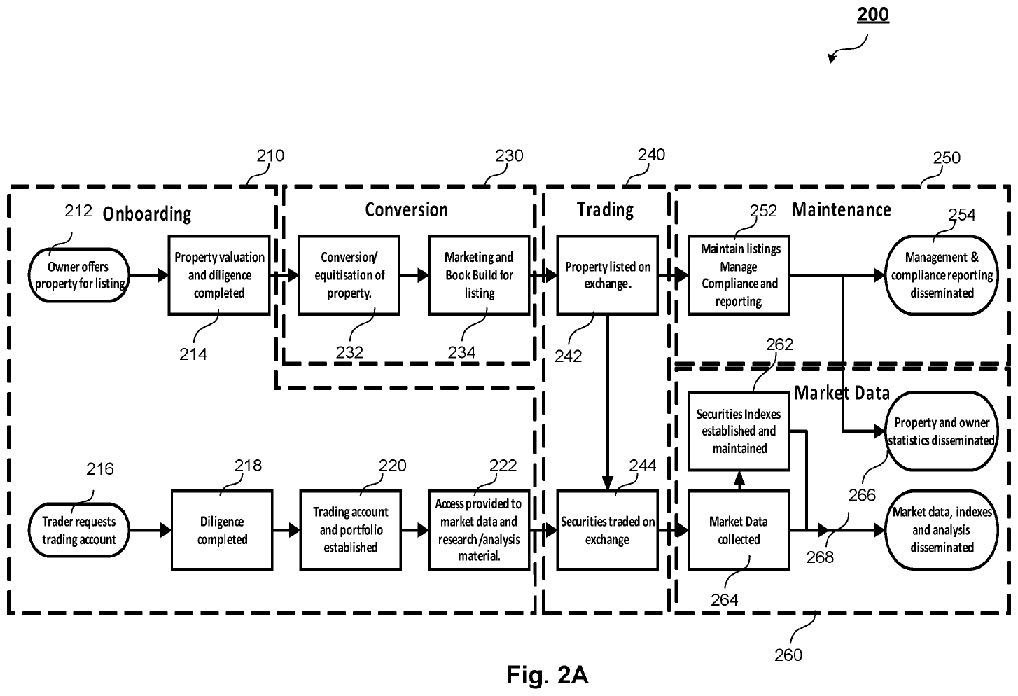

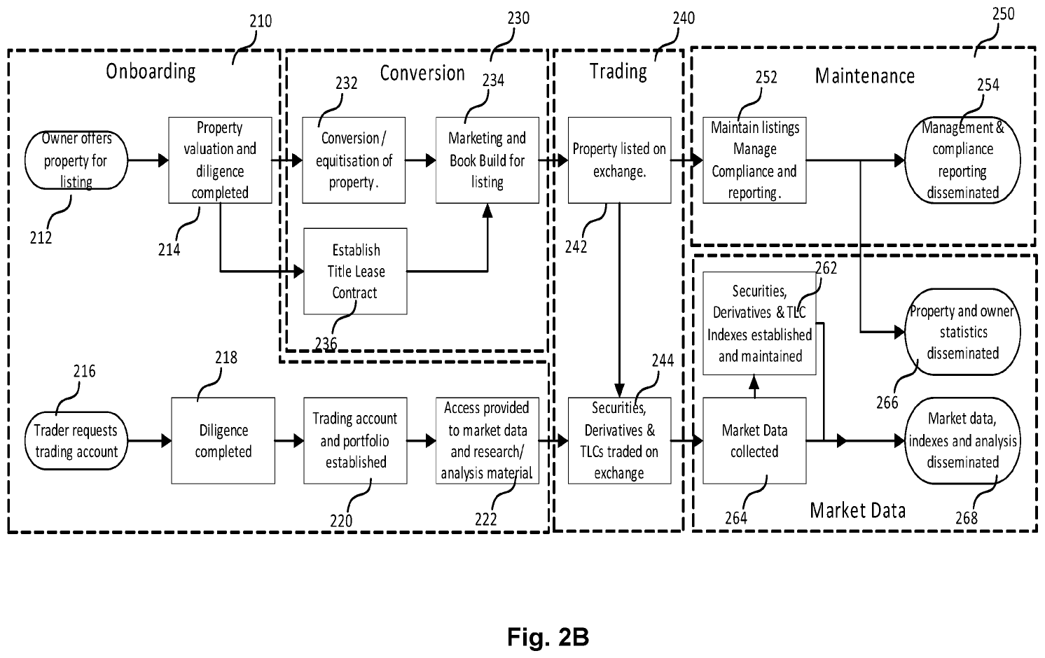

FIG. 2A is a schematic representation of a method 200 of property trading in accordance with the present disclosure. The method 200 includes the following phases:
i. Onboarding 210;
ii. Conversion 230;
iii. Trading 240;
iv. Maintenance 250; and
v. Market Data 260.

Onboarding 210 relates to an initial phase in which the participating property owner 802 offers their property 850 for conversion using the property platform implemented using a networked computer system 801. During the onboarding process 210, the property owner 802 is able to view product information and associated terms and conditions for listing their property 850. The property owner 802 provides basic personal and property information. The property trading system 801 processes the received personal and property information against stored market data, market indices, and external property valuation services to produce and provide the customer with a cursory valuation and public offering (PO) proposal. The system 801 optionally provides the property owner 802 with a comparative report of relevant competitor products.

The onboarding phase 210 includes an initial step 212 in which the user 802 offers the property 850 for listing. In step 214, the platform 801 performs property valuation and due diligence relating to offering the property 850 for conversion.

Detailed personal and property information provided by the property owner 802 is processed against APTEX market data, APTEX market indices, and external property valuation services to produce and provide the customer with a detailed valuation and proposal, which is suitable for contract development. The property trading system 801 also performs analysis against owner and title identification, financial history data, compliance with specific APTEX market rules, and standing regulatory compliance to produce a risk score and determine qualification for contract development.

In parallel with the user 802 listing the property 850 for sale, one or more traders 885, 895 access computing devices 880, 890 to register with the property trading platform 801. I n FIG. 2A, the registration of a trader is shown in step 216, in which a trader requests a trading account. In step 218, the property platform 801 performs due diligence, and establishes a trading account for the trader by establishing a trading account and an associated portfolio, which the property platform 801 stores in the user database 848. The property platform 801 also grants the newly registered trader access to market data and analysis materials stored on the database 870.

The conversion phase 230 creates an appropriate and exclusive entity to which the property will be transitioned. The property trading system 801 creates the appropriate entity through processing relevant property details through the APTEX property incorporation processor and is supported by connection to public and private corporate registry services. The conversion phase 230 then transitions the property to the specific entity processing property and entity details through the APTEX transition system and database, supported by connection to public and private conveyancing services.

The property trading system 801 executes a final property audit to ensure compliance with APTEX prospectus and listing requirements. Property details are processed by the APTEX listing compliance system and database. Remediation of outstanding audit points is achieved by connection to external service providers, including insurance vendors, utility providers and property certifiers. The system 801 processes property details using an APTEX Securities structure and pricing processor, along with the APTEX market data system and database, to produce the final entity and securities structure.

The conversion phase 230 receives the property valuation from step 214. In step 232, the conversion phase 230 converts the property 850 into a set of shares, based on the property valuation from step 214. In step 234, the conversion phase 230 performs marketing and generating of a book build for listing of shares in the property 850. An APTEX bookbuild processor compiles all relevant property and owner details and processes input from external RE marketing service to produce a prospectus, initiate and track a marketing campaign and subsequent securities sales. The conversion phase also collects and distributes the proceeds of PO/securities sales. The APTEX clearing and settlement processor calculates, clears and settles all proceeds, and distributes the proceeds as contracted. The property/entity is officially listed for trading by the APTEX listing registry and maintenance processor and all relevant maintenance schedules are initiated.

The trading phase 240 enables registered trading customers to access the trading platform 846 via Internet browser, mobile phone “app”, or voice interface. Registered customers are able to view and analyse their personal portfolio of securities, analyse their holdings, history and performance modeling. Trader accounts and portfolios are processed and transacted by an APTEX Trade portfolio processor system and associated database. Analysis of holdings is executed by integration of the APTEX market data processor and associated database.

Registered customers are also able to view real time market data and research for all listed securities, performance modeling and market indexes. Further, registered customers can place, review and amend orders to buy and sell listed ordinary securities.

All orders are placed through an APTEX order routing processor and handled by the order matching and contract processor. When executed, contract settlement is processed through an APTEX clearing and settlement processor, and financial settlement is transacted directly with trader settlement account FI's. Registered customers are further able to place, review and amend orders to buy and sell listed preferential securities.

Preferential securities can only be traded in predefined block sizes for any given property/entity, wherein the predefined block sizes may range from small parcels of preferential shares through to a single block corresponding to the entire property/entity. As described above in relation to the apartment block example, the predefined block sizes may correspond, for example, to a set of one or more apartments within an apartment block. Similarly, block sizes of preferential shares may correspond to different floors of an office block. An order to sell a block of preferential shares is a market notifiable event and is subject to mandatory notice periods. The order for sale is processed through the APTEX extraordinary order matching and contract processor, market notification is executed through the APTEX market data processor, and a specific marketing campaign is initiated and tracked through connection to contracted real estate market services.

In an arrangement in which a property is converted to equity securities and related derivatives, registered customers can place, review and amend orders to buy and sell securities and derivatives, including any associated discounted share options.

In an arrangement in which a property is converted entirely to ordinary securities and the system generates an associated TLC, the system provides a platform for registered customers to place, review and amend orders to buy and sell listed TLCs. TLCs can be traded for any given property/entity. An order to sell a TLC is a market notifiable event and subject to mandatory notice periods. The order for sale is processed through the APTEX extraordinary order matching and contract processor, market notification is executed through the APTEX market data processor and a specific marketing campaign initiated and tracked through connection to contracted real estate market services.

The trading phase 240 receives the conversion information and lists the property on the trading platform 846 of the property platform 801. Shares in the property 850 listed in step 242 are now available to be bought and sold in step 244 by traders 885, 895 registered with the property trading platform 801.

The maintenance phase 250 relates to regulatory and commercial maintenance functions performed over time and includes periodic audits on the listed entities and related properties and determination and execution of remedies to ensure audit compliance. For example, the maintenance phase 250 ensures appropriate insurance is current for property of a listed entity. Where the audit and reporting processors identify an audit gap, the APTEX maintenance processor enforces compliance by acquiring appropriate insurance cover. The property trading system 801 gathers relevant data for listed entities and related properties, then develops and delivers periodic reporting to investors/security holders and regulatory bodies.

The maintenance phase 250 may also, where appropriate, monitor the collection of TLC payments revenue and then calculate and distribute dividends to investors. In such an arrangement, a Title Lease Payments Processor collects and monitors TLC payment revenue. A Dividend Payment Processor collects data from a listing registry database, then determines and distributes dividends payments to respective investors. As described above, one arrangement determines dividends for a particular shareholding based on the period of time for which that shareholding has been held by the owner. In such an arrangement, the dividend for that shareholding will accrue in real-time and be paid periodically.

The maintenance phase 250 may also calculate, process, and distribute TLC holder entitlements, such as discounted share options. In one implementation, a TLC Holder Entitlements Qualification & Distribution Processor gathers equity ownership data from a trade portfolio database and then determines and distributes appropriate entitlements, such as discounted share options, to the respective TLC holders.

The maintenance phase 250 and market data phase 260 run concurrently. The maintenance phase 250 receives data from the property listing in step 242 and in step 252 maintains listings of all properties available on the trading platform 846. Step 254 optionally generates maintenance and compliance reports for dissemination to relevant parties, which may include one or more of the user 802, the traders 885, 890, an administrator of the trading platform 801, or government or regulatory authorities.

The market data systems comprise networked computer processors, applications and databases, which provide trading customers and market data consumers with the following functions:
i. To request and receive quotes for listed securities and derivatives, including discounted share options, where appropriate;
ii. To request and receive quotes for listed TLCs; and
iii. To request and receive detailed securities and market analysis.

All routed and matched orders are processed by the APTEX market data processor and a related database to provide real time securities pricing, volume and depth, as well as detailed property performance and modeling data.

The market data phase 260 also enables registered customers to request and receive detailed market property reports and valuation. The APTEX market data and analysis, combined with property details gathered through the APTEX conversion and maintenance stages, produce detailed real time property valuation and modeling reports. Registered customers can also view real time market indices. For example, real-time APTEX property performance data is grouped by defined area to produce one or more respective market indices.

Step 252 also feeds maintenance data to the market data phase 260. In particular, step 266 receives maintenance data from step 252 and disseminates property and owner statistics to relevant parties. Step 264 of the market data phase 260 receives data from the trading of securities in step 244. The received data is fed from step 264 to each of step 262, which establishes and maintains one or more securities indices, and step 268, which disseminates one or more of market data, market indices, and market analysis.

FIG. 2B is an alternative arrangement to that shown in FIG. 2A, wherein the method 200 of property trading is adapted to handle TLCs. In the arrangement of FIG. 2B, the conversion phase 230 includes an Establish Title Lease Contract module 236, which receives a property valuation and diligence information from step 214 and provides a TLC to step 234 for the marketing and generating of a book build.

In FIG. 2B, step 244 relates to the trading not only of securities on an exchange, but also derivatives and TLCs. Further, step 262 is expanded to establish and maintain indices across securities, derivatives, and TLCs.

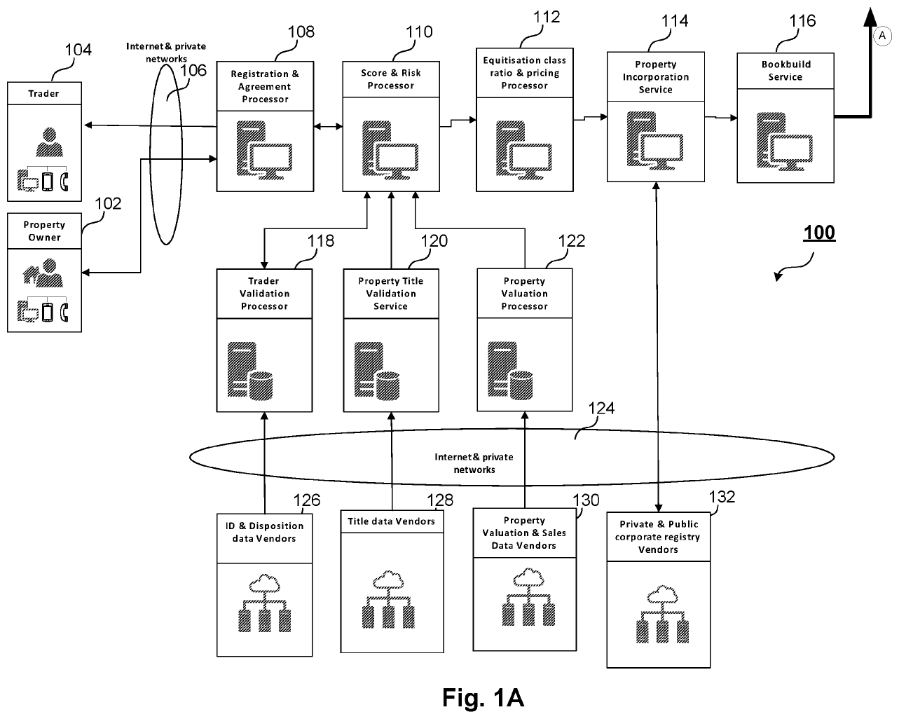

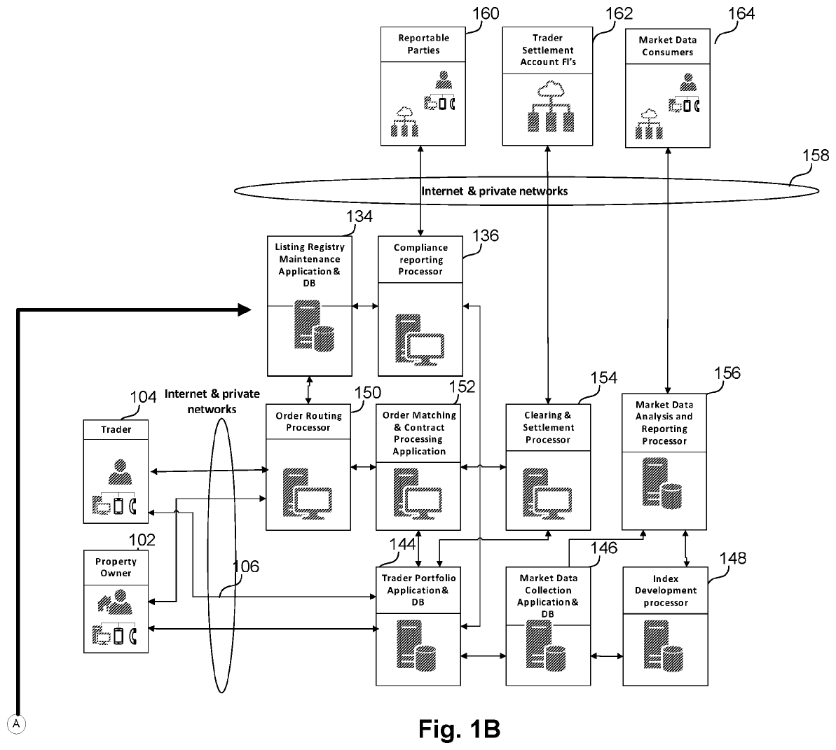

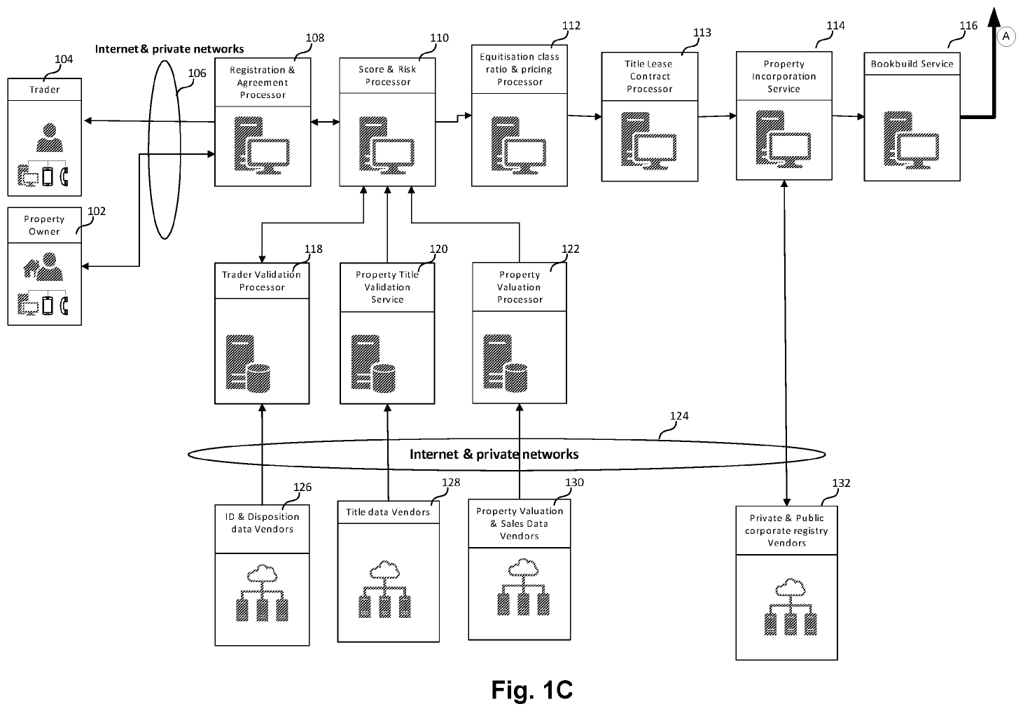

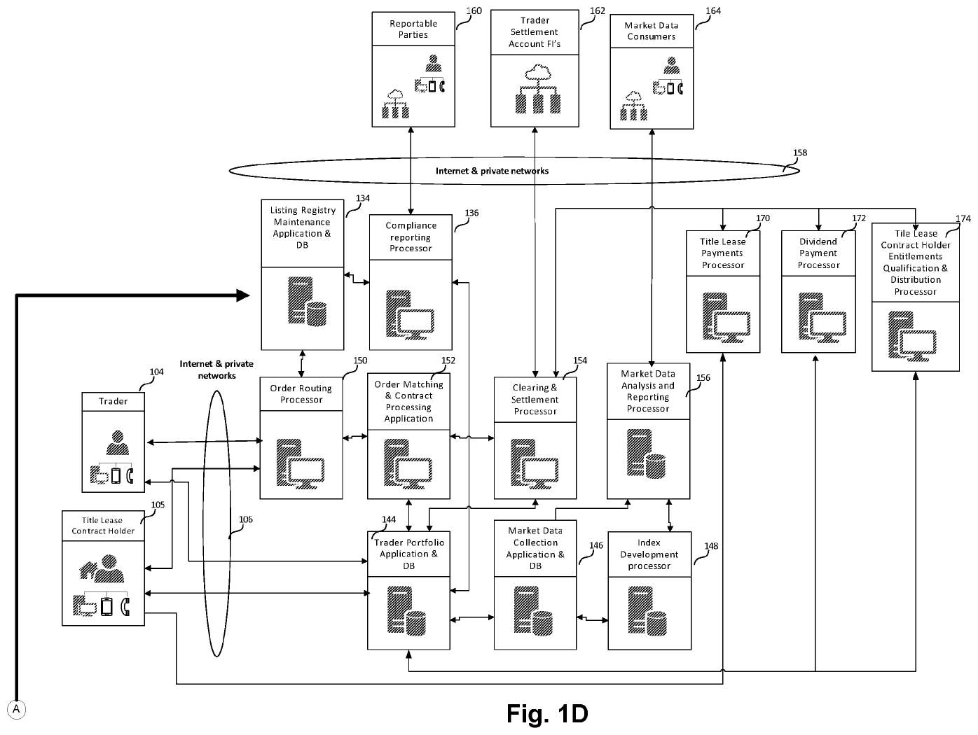

FIGS. 1A and 1B are schematic representations illustrating flow of information through a property trading system 100. FIG. 1A shows a set of external service providers connected to a communications network 124, which may include the Internet and one or more private networks. The external service providers include Identity and Financial History Data Vendors 126, Title Data Vendors 128, Property Valuation and Sales Data Vendors 130, and Private and Public Corporate Registry Vendors 132.

The Identity and Financial History Data Vendors 126 present information to a Trader Validation Processor 118 of the property trading system 100, which in turn is coupled to a Score and Risk Processor 110. The Title Data Vendors 128 present information to a Property Title Validation Service 120, which in turn is coupled to the Score and Risk Processor 110. The Property Validation and Sales Data Vendors 130 present information to a Property Valuations Processor 122, which is also coupled to the Score and Risk Processor 110. The Private and Public Corporate Registry Vendors 132 present information to a Property Incorporation Service 114.

A Trader 104 and a Property Owner 102 use computing devices coupled to a communications network 106 to interact with the property trading system 100, via a Registration and Agreement Processor 108, which is coupled to the Score and Risk Processor 110. The Score and Risk Processor 110 is coupled to an Equitisation Class Ratio and Pricing Processor 112, which presents information to the Property Incorporation Service 114. The Property Incorporation Service 114 presents information to a Bookbuild Service 116, which presents an output, labeled A, that is received on FIG. 1B as an input to a Listing Registry Maintenance Application and Database 134.

The Listing Registry Maintenance Application and Database 134 is coupled to each of a Compliance Reporting Processor 136 and an Order Routing Processor 150. The Order Routing Processor 150 is adapted to receive order information from each of the Trader 104 and the Property Owner 102.

A Trader Portfolio Application and Database 144 is also adapted to receive information from each of the Trader 104 and the Property Owner 102. The Trader Portfolio Application and Database 144 is coupled to each of the Compliance Reporting Processor 136, a Market Data Collection Application and Database 146, a Clearing and Settlement Processor 154 and an Order Matching and Contract Processing Application 152. The Order Matching and Contract Processing Application 152 is also coupled to the Order Routing Processor 150 and the Clearing and Settlement Processor 154.

The Market Data Collection Application and Database 146 is also coupled to each of an Index Development Processor 148 and a Market Data Analysis and Reporting Processor 156. The Index Development Processor 148 is also coupled to the Market Data Analysis and Reporting Processor 156.

The Compliance Reporting Processor 136 is coupled, via a communications network 158, to Reportable Parties 160. The Clearing and Settlement Processor 154 is coupled via the communications network 158 to Trader Settlement Account Financial Institutions (FIs) 162. The Market Data Analysis and Reporting Processor 156 is coupled via the communications network 158 to Market Data Consumers 164. It will be appreciated that the communications networks 106, 124, 158 may relate to any one or more communications networks and may, in fact, refer to the same communications network comprising, for example, one or more wired or wireless connections, including a Local Area Network (LAN), Wide Area Network (WAN), a virtual private network (VPN), cellular telephony network, the Internet, or any combination thereof.

FIGS. 1C and 1D are schematic representations illustrating flow of information through a property trading platform, in which a property can be converted for trading and listed entirely as ordinary securities, in association with a TLC. The flow is similar to that described above with reference to FIGS. 1A and 1B. However, FIG. 1C has a Title Lease Contract (TLC) Processor 113 situated between the Equitisation Class Ratio and Pricing Processor 112 and the Property Incorporation Service 114. The TLC Processor 113 compiles relevant pricing and conditional data from the Market Data Analysis & Reporting Processor 156 for the respective property and then develops appropriate terms and conditions and generates an initial Title Lease Contract, which is presented to the Property Incorporation Service 114.

FIG. 1D shows various modules associated with a TLC, including a Title Lease Payments Processor 170, a Dividend Payment Processor 172, and a Title Lease Contract Holder Entitlements Qualification and Distribution Processor 174, each of which is coupled to the Clearing and Settlement Processor 154. A Title Lease Contract Holder 105, which interacts with each of the Order Routing Processor 150, the Trader Portfolio Application and Database 144, and the Title Lease Payments Processor 170. The Dividend Payment Processor 172 and the Title Lease Contract Holder Entitlements Qualification and Distribution Processor 174 are also coupled to the Trader Portfolio Application and Database 144.

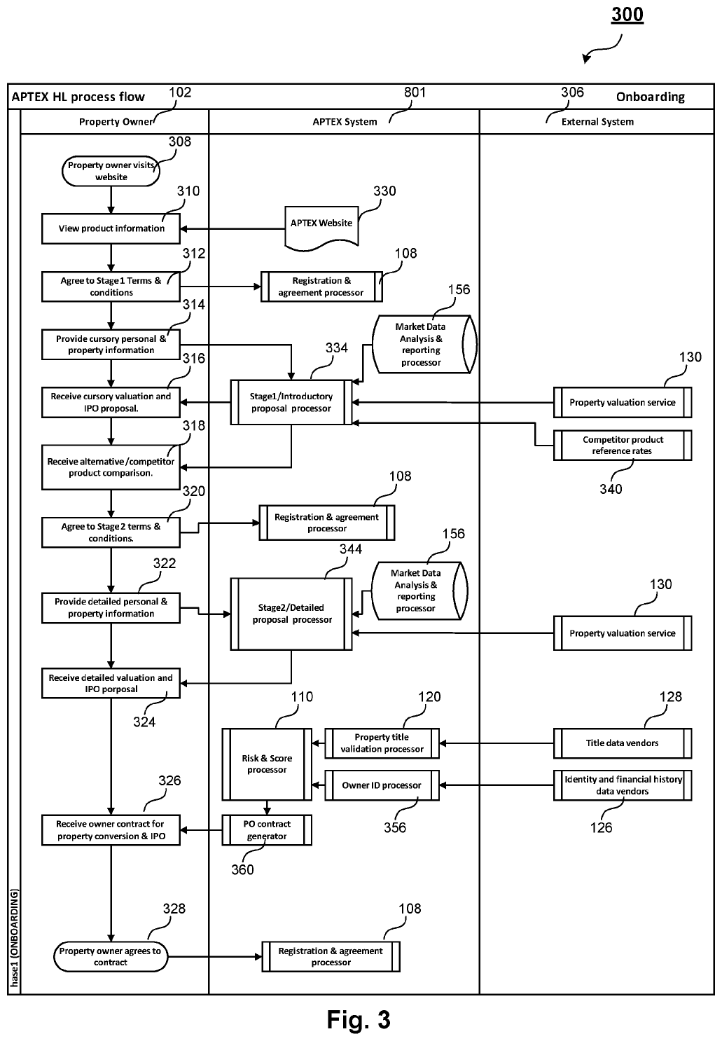

FIG. 3 is a flow diagram of the onboarding phase 210 of a method of property trading. The onboarding phase 210 illustrates actions between the property owner 102, the Property Trading System 801, referred to herein as the APTEX system, and an external system 306. In step 308, the Property Owner 102 uses the first computing device 810 to visit the property trading system 801, shown in FIG. 3 as the APTEX website. In step 310, the user 802 views product information and in step 312 agrees to predefined Terms and Conditions associated with the property trading system 801, wherein registration information is provided to the Registration And Agreement Processor 108 of the server 840.

In step 314, the user 802 provides cursory personal contact information and property information. In the FIG. 3, an external Property Valuation Service 130 and a Competitor Product Reference Rates module 340 provide data to an Introductory Proposal Processor 334. The Introductory Proposal Processor 334 also receives an input from a Market Data Analysis and Reporting Processor 156 of the server 840. In step 316, the property trading system 801 provides to the user 802 a cursory property valuation and proposal for an initial public offering (IPO) for shares in the property nominated in step 314, as a result of calculations performed by the Introductory Proposal Processor 334.

Control passes from step 316 to step 318, in which the Introductory Proposal Processor 334 provides the Property Owner 102 with an alternative/competitor product comparison. In step 332, the Property Owner 102 agrees to Stage 2 terms and conditions, which are fed to the Registration Processor 108. In step 332, the user 802 provides detailed personal and property information. The detailed personal and property information is passed to a Stage 2/Detailed Proposal Processor 344, which also receives input from each of the Market Data Analysis And Reporting Processor 156 and an external Property Valuation Service 130. In step 324, the Stage 2 Processor 344 provides a detailed valuation and IPO proposal to the Property Owner 102.

An external Title Data Vendor 128 provides an input to a Property Title Validation processor 120 of the server 840. An external Identity and Financial History Data Vendor 126 provides an input to an Owner ID Processor 356 of the server 840. The Property Title Validation Processor 120 and Owner ID Processor 356 provide respective inputs to the Risk and Score Processor 110 of the server 840, which feeds an output to a Public Offering Contract Generator 360 of the server 840. In step 326, the Public Offering Contract Generator 360 pushes an owner contract for property conversion and the IPO to the user 802. In step 328, the Property Owner 102 agrees to the contract, with the signed contract being passed back to the registration processor 332 of the server 840.

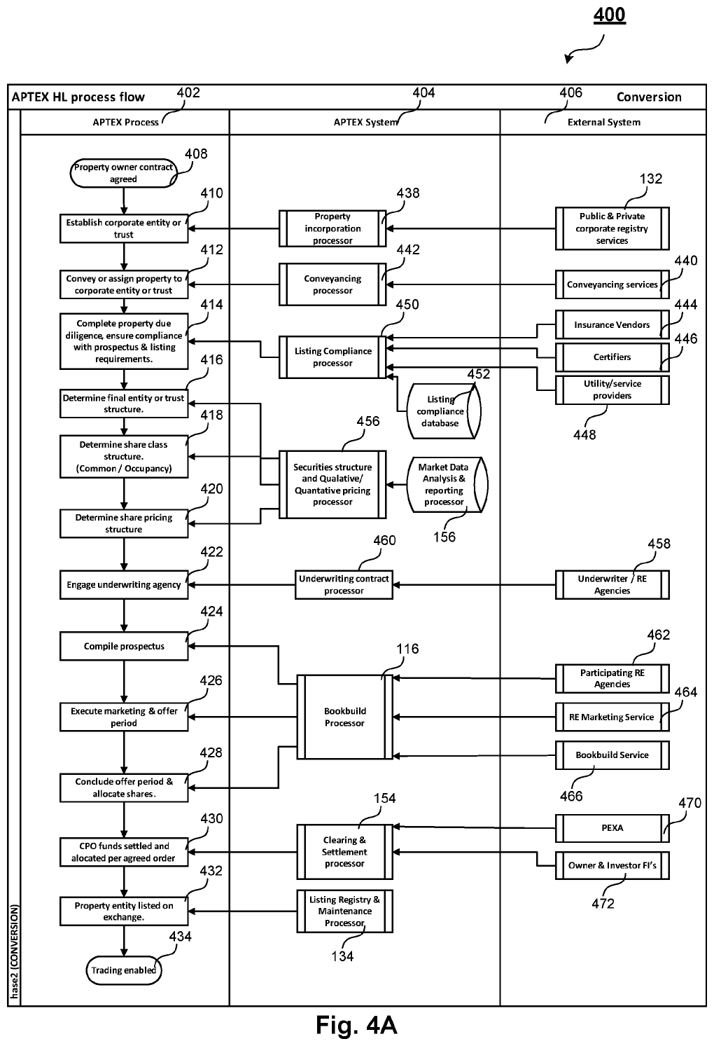

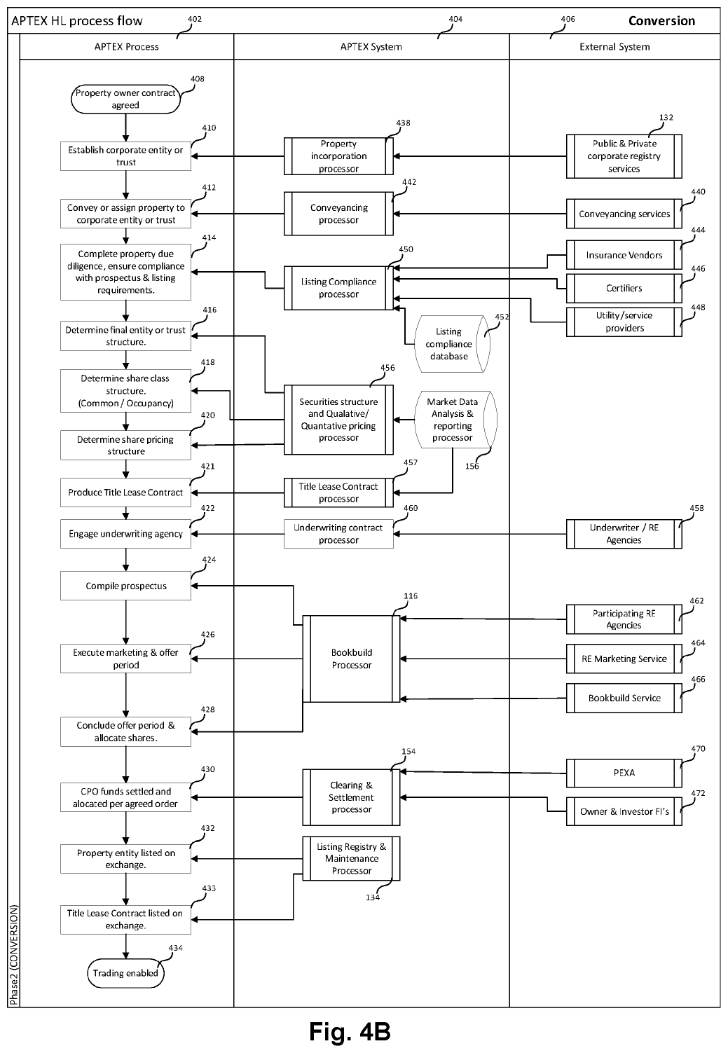

FIG. 4A is a flow diagram of the conversion phase 230 of a method of property trading. The conversion phase 230 illustrates actions between an APTEX process 402, a Property Trading System 404, referred to herein as the APTEX system, and an external system 406. In step 408, the Property Owner 102, corresponding to the user 802 of FIG. 8, agrees to a contract offered in the onboarding phase 210. An external Public and Private Corporate Registry Service 132 provides input to a Property Incorporation Processor 438 of the APTEX system 404, which provides an input to step 410, which establishes a corporate entity for the owner 402.

In step 440, an external Conveyancing Service 440 provides input to a Conveyancing Processor 442 of the APTEX system 404, which in turn presents conveyancing information to step 414, which conveys or assigns the property 850 to the registered corporate entity established in step 412.

One or more external Insurance Vendors 444, Certifiers 446, and Utility Providers 448 provide inputs to a Listing Compliance Processor 450 of the APTEX system 804. The Listing Compliance Processor 450 also receives input from a Listing Compliance Database 452 of the APTEX system 404, which may be stored, for example, in the database 870 of FIG. 8. The Listing Compliance Processor 450 provides an input to step 414, which completes property due diligence and ensures that a property listing for the property 850 complies and prospectus and listing requirements. A Market Data Analysis and Reporting Processor 156 provides an input to a Securities Structure Processor 456, which provides an input to step 416, which determines a final entity for the owner 402. Step 418 determines a share class structure for the sale of the property 850 and step 420 determines a share pricing structure.

An external Underwriter 458 provides input to an Underwriting Contract Processor 460 of the APTEX system 404, which in turn provides input to step 422, whereby the owner 4040 engages an underwriting agency. A Bookbuild Processor 116 of the APTEX system 404 receives inputs from each of a Participating Real Estate Agency 462, a Real Estate Marketing Service 464, and a Bookbuild Service 466 and produces outputs to each of steps 424, 426, and 428. Step 424 compiles a prospectus, step 426 executes a marketing and offer period, and step 428 concludes the offer period and allocates shares in the property 850.

One or more property settlement and exchange bureaux 470, such as the Property Exchange Australia Ltd (PEXA), and Owner and Investor FIs 472 provide inputs to a Clearing and Settlement Processor 154 of the APTEX system 404. The Clearing and Settlement Processor 154 provides input to step 430, which settles and allocates IPO as per an agreed order.

A Listing Registry and Maintenance Processor 134 provides an input to step 432, which lists the property entity on an exchange operated by the trading platform 846. In step 434, trading in the property entity is enabled.

FIG. 4B is a flow diagram of an alternative arrangement of the conversion phase 230 of a method of property trading, wherein the method is adapted to incorporate derivatives and TLCs. In the flow diagram of FIG. 4B, the output of step 420, which determines a share pricing structure, is presented to step 421, which produces a Title Lease Contract. Step 421 also receives, as an input, an output from the Market Data Analysis and Reporting Processor 156. The output of step 421, in the form of a TLC, is presented to step 422, whereby the owner engages an underwriting agency.

FIG. 4B also includes a further step 433. Once the property entity is listed on the exchange in step 432, the method passes to step 433, in which the TLC is listed on the exchange, with step 433 receiving an input from the Listing Registry and Maintenance Processor 134. Control then passes from step 433 to step 434, in which trading is enabled.

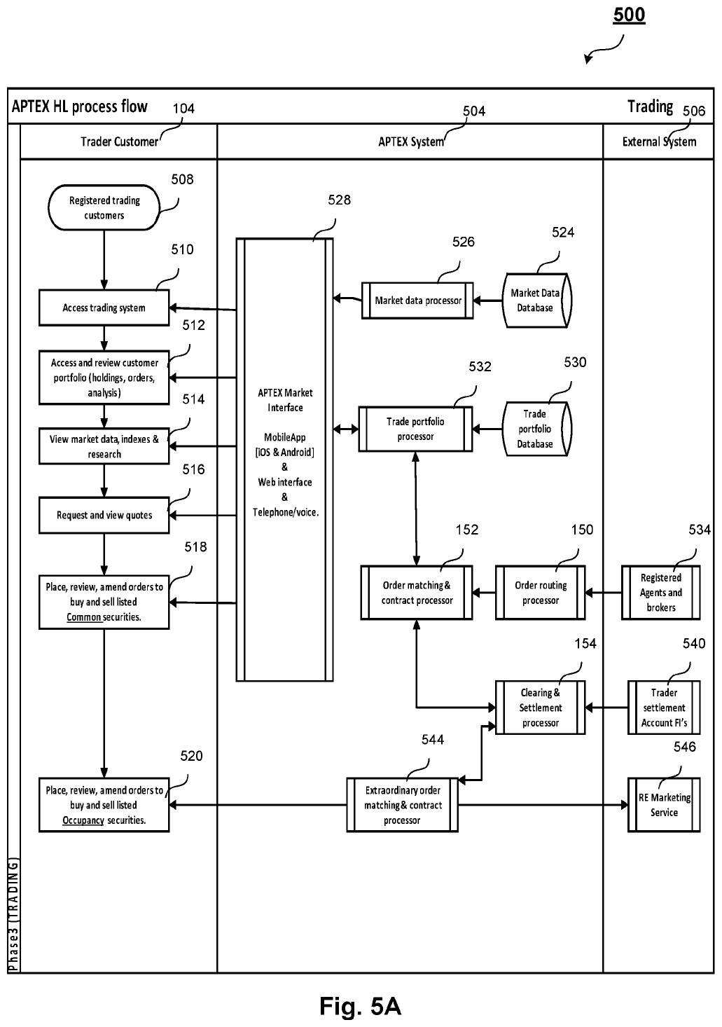

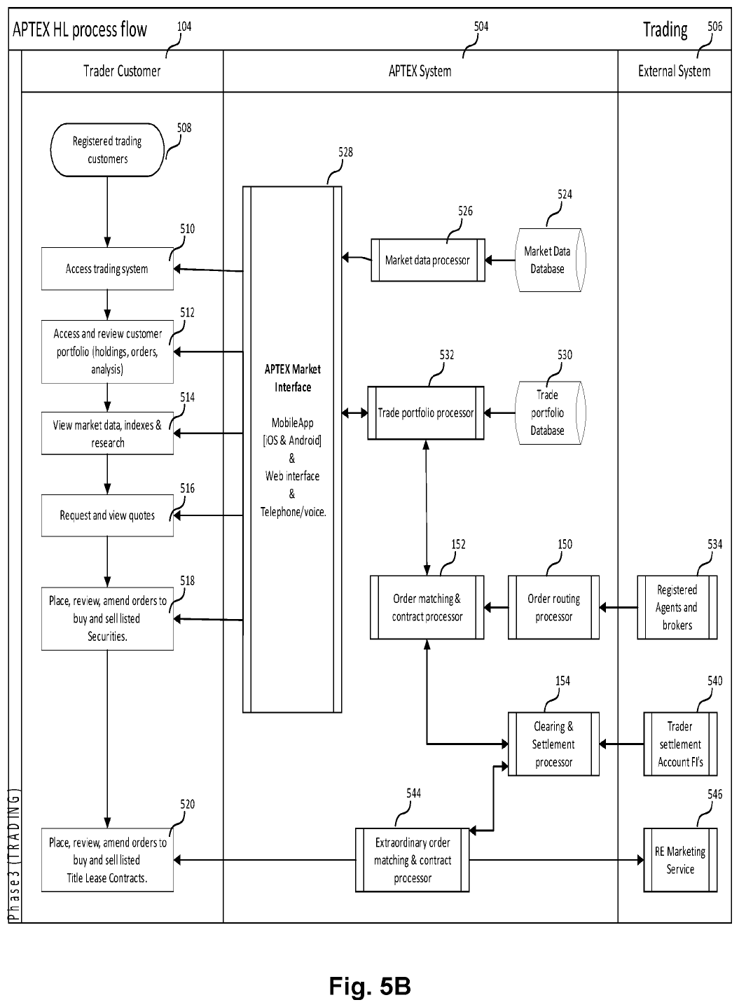

FIG. 5A is a flow diagram of the trading phase 240 of a method of property trading. The trading phase 240 illustrates actions between a Trader 104, a property trading system 504, referred to herein as the APTEX system, and an external system 506. In step 508, traders are registered with the APTEX system 504, corresponding to the platform trading system 801 of FIG. 8. The APTEX system 504 includes a Market Data Processor 526, which receives input from a Market Data Database 524 and provides an input to an APTEX Market Interface 528. A Trade Portfolio Processor 532 receives an input from a Trade Portfolio Database 530 and provides an input to the APTEX Market Interface 528.

The Trade Portfolio Processor 532 also communicates with an Order Matching and Contract Processor 152, which receives input from an Order Routing Processor 150 and a Clearing and Settlement Processor 154. The Order Routing Processor 536 receives information from external Registered Agents and Brokers 534. The Clearing and Settlement Processor 154 receives information from each of an external Trader Settlement Account module 540 and an Extraordinary Order Matching and Contract Processor 544 of the APTEX system 504. The Extraordinary Order Matching and Contract Processor 544 produces an output that is presented as an input to a Real Estate Marketing System 546.

In step 510, the user 502 accesses the trading system using the APTEX Market Interface 528. Step 512 retrieves and reviews the customer's portfolio. In step 514, the trading customer 502 views market data, indices, and research. In step 516, the trading user requests and views quotes relating to one or more traded properties. In step 518, the trading user, places, reviews, and amends orders to buy and sell listed common securities.

In step 520, the trading user places, reviews, and amends orders to buy and sell listed preferential securities.

FIG. 5B is an alternative arrangement to that shown in FIG. 5A, in which step 520 is expanded to incorporate functionality to place, review, and amend orders to buy and sell listed TLCs.

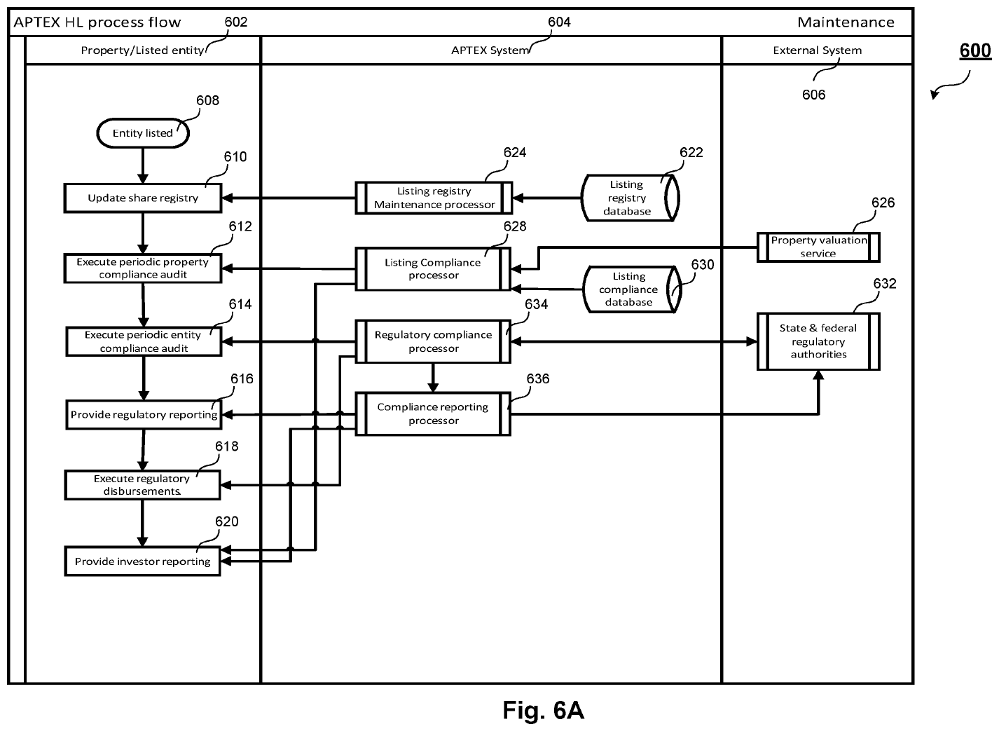

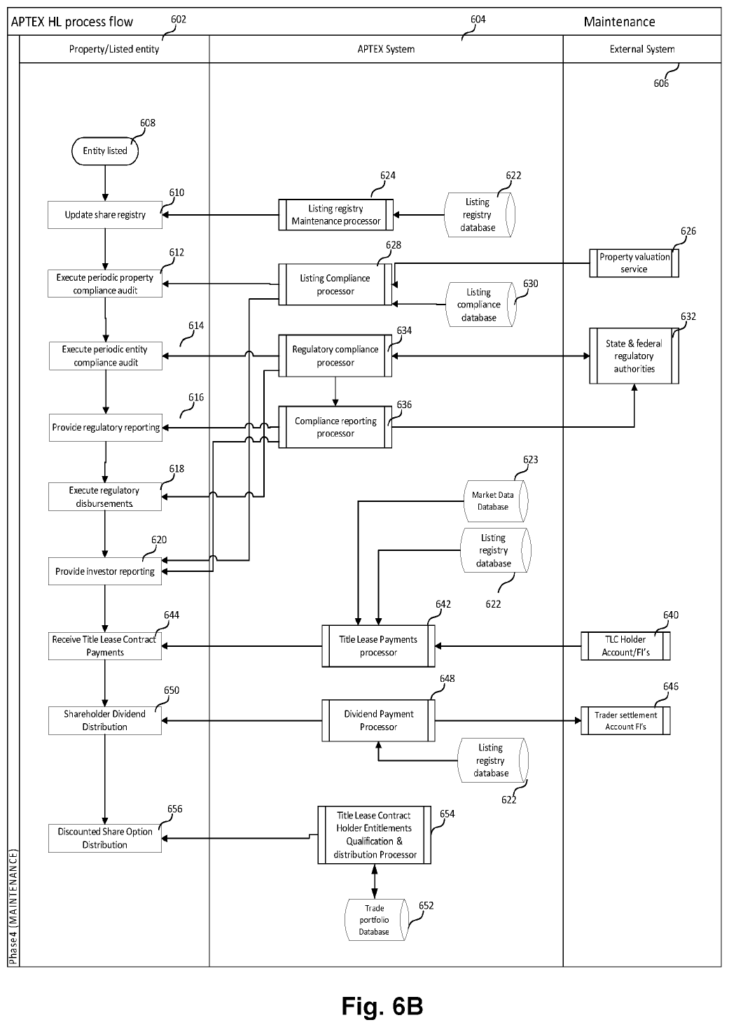

FIG. 6A is a flow diagram of the maintenance phase 250 of a method of property trading. The maintenance phase 250 illustrates actions between a listed entity 602, a property trading system 604, referred to herein as the APTEX system, and an external system 606. In step 608, an entity is listed. A Listing Registry Database 622 of the APTEX system 604 provides an input to a Listing Registry Maintenance Processor 624, which in turn provides an input to step 610, which updates a share registry for the listed entity 602. An external Property Valuation Service 626 and a Listing Compliance Database 630 provide inputs to a Listing Compliance Processor 628, which feeds to steps 612 and 620.

Step 612 executes a periodic property compliance audit for the listed entity 602. Step 614 performs a periodic entity compliance audit, receiving an input from a Regulatory Compliance Processor 634 of the APTEX system 604, which exchanges information with external Regulatory Authorities 632. The Regulatory Compliance Processor 634 feeds to a Compliance Reporting Processor 636, which provides an input to step 620.

From step 614, control passes to step 616, which performs periodic regulatory reporting and step 618 executes regulatory disbursements. Step 620 provides investor reporting.

FIG. 6B is a flow diagram of the maintenance phase 250 of a method of property trading suitable for use in trading derivatives and TLCs. In addition to the steps of FIG. 6A, FIG. 6B includes a TLC Holder Account module 640, which presents an input to a Title Lease Payments Processor 642. The Title Lease Payments Processor 642 also receives an input from the Listing Register Database 622, which provides the relevant information in order for the Title Lease Payments Processor 642 to calculate prorated lease payments, where applicable, and an input from a Market Data Database 623. The Market Data Database 623 stores information relevant to calculating title lease payments, such as, for example, trading data pertaining to trade volumes over time and rate of equities price variation over time. The output of the Title Lease Payments Processor 642 is presented to step 644, which receives an output of step 620 and receives Title Lease Contract Payments.

FIG. 6B also includes a Dividend Payment Processor 648, which receives input from the Listing Registry Database 622. The Dividend Payment Processor 648 provides an output received by a Trade Settlement Account module 646. The Dividend Payment Processor 648 also presents an output received by step 650. Step 650 receives the output from step 644 and the output from the Dividend Payment Processor 648 and distributes shareholder dividends. Control passes from step 650 to step 656, which distributes discounted share options. A trade portfolio database 652 exchanges information with a Title Lease Contract Holder Entitlements Qualification & Distribution Processor 654, which presents an input to step 656 to enable step 656 to perform its task.

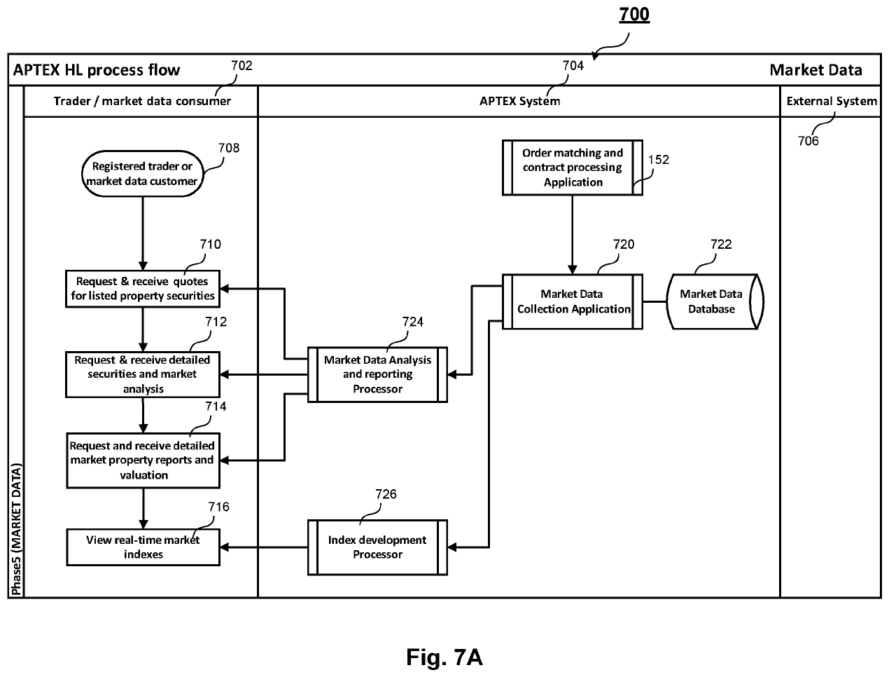

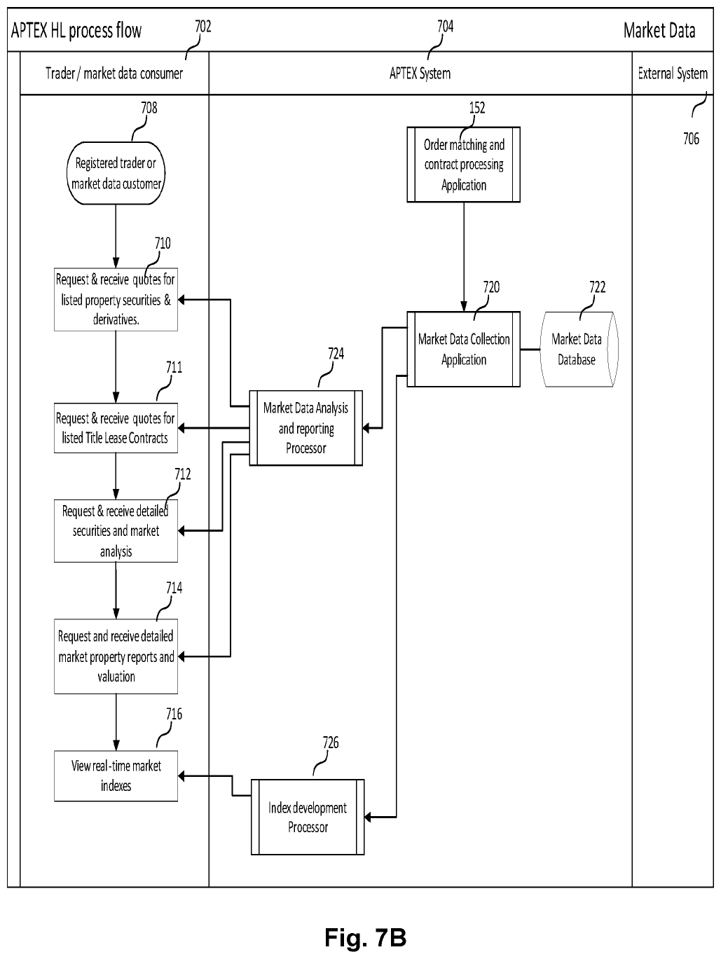

FIG. 7A is a flow diagram of the market data phase 260 of a method of property trading. The market data phase 260 illustrates actions between a trader/market data consumer 702, a property trading system 704, referred to herein as the APTEX system, and an external system 706. In step 708, a registered trader enters the system. The APTEX system 704 includes an Order Matching Contract Processing Application 152, which feeds to a Market Data Collection Application 720, which is coupled to a Market Data database 722. The Market Data Collection Application 720 provides data to each of a Market Data Analysis and Reporting Processor 724 and an Index Development Processor 726. The Market Data Analysis and Reporting Processor 724 provides data to each of steps 710, 712, and 714. In step 710, the trader requests and receives quotes for listed property securities. In step 712, the trader requests and receives detailed securities and market analysis. In step 714, the trader requests and receives detailed market property reports and valuations. In step 716, the trader views real-time market indices, the data for which is received from the Index Development Processor 726.

FIG. 7B is a flow diagram of an alternative market data phase of a method of property trading, based on that described with reference to FIG. 7A. In FIG. 7B, step 710 is adapted to request and receive quotes for listed property securities and derivatives. A new step 711 follows step 710, wherein step 711 requests and receives quotes for listed TLCs, step 711 receiving input data from the Market Data Analysis & Reporting Processor 724. Control passes from step 711 to step 712, as described with reference to FIG. 7A.

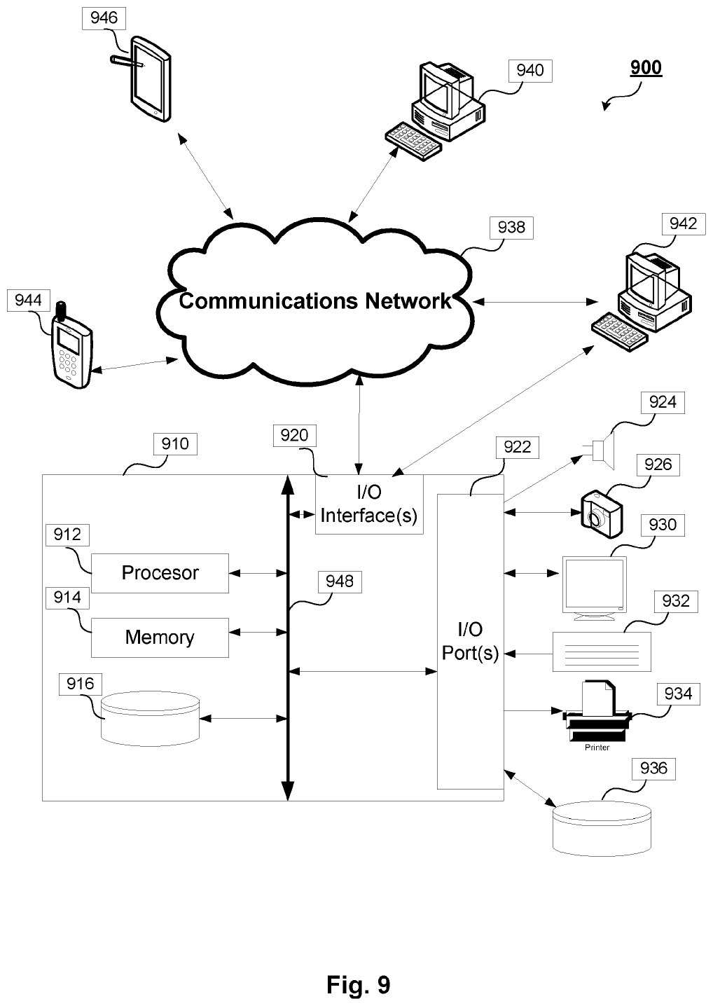

The property trading system of the present disclosure may be practised using a computing device, such as a general purpose computer or computer server. FIG. 9 is a schematic block diagram of a system 900 that includes a general purpose computer 910. The general purpose computer 910 includes a plurality of components, including: a processor 912, a memory 914, a storage medium 916, input/output (I/O) interfaces 920, and input/output (I/O) ports 922. Components of the general purpose computer 910 generally communicate using one or more buses 948.

The memory 914 may be implemented using Random Access Memory (RAM), Read Only Memory (ROM), or a combination thereof. The storage medium 916 may be implemented as one or more of a hard disk drive, a solid state “flash” drive, an optical disk drive, or other storage means. The storage medium 916 may be utilised to store one or more computer programs, including an operating system, software applications, and data. In one mode of operation, instructions from one or more computer programs stored in the storage medium 916 are loaded into the memory 914 via the bus 948. Instructions loaded into the memory 914 are then made available via the bus 948 or other means for execution by the processor 912 to implement a mode of operation in accordance with the executed instructions.

One or more peripheral devices may be coupled to the general purpose computer 910 via the I/O ports 922. In the example of FIG. 9, the general purpose computer 910 is coupled to each of a speaker 924, a camera 926, a display device 930, an input device 932, a printer 934, and an external storage medium 936. The speaker 924 may be implemented using one or more speakers, such as in a stereo or surround sound system. In the example in which the general purpose computer 910 is utilised to implement the computing device 810, one or more peripheral devices may relate to a printer, camera, or external memory drive connected to the I/O ports 922.

The camera 926 may be a webcam, or other still or video digital camera, and may download and upload information to and from the general purpose computer 910 via the I/O ports 922, dependent upon the particular implementation. For example, images recorded by the camera 926 may be uploaded to the storage medium 916 of the general purpose computer 910. Similarly, images stored on the storage medium 916 may be downloaded to a memory or storage medium of the camera 926. The camera 926 may include a lens system, a sensor unit, and a recording medium.

The display device 930 may be a computer monitor, such as a cathode ray tube screen, plasma screen, or liquid crystal display (LCD) screen. The display 930 may receive information from the computer 910 in a conventional manner, wherein the information is presented on the display device 930 for viewing by a user. The display device 930 may optionally be implemented using a touch screen to enable a user to provide input to the general purpose computer 910. The touch screen may be, for example, a capacitive touch screen, a resistive touchscreen, a surface acoustic wave touchscreen, or the like.

The input device 932 may be a keyboard, a mouse, a stylus, drawing tablet, or any combination thereof, for receiving input from a user. The external storage medium 936 may include an external hard disk drive (HDD), an optical drive, a floppy disk drive, a flash drive, or any combination thereof and may be implemented as a single instance or multiple instances of any one or more of those devices. For example, the external storage medium 936 may be implemented as an array of hard disk drives.

The I/O interfaces 920 facilitate the exchange of information between the general purpose computing device 910 and other computing devices. The I/O interfaces may be implemented using an internal or external modem, an Ethernet connection, or the like, to enable coupling to a transmission medium. In the example of FIG. 9, the I/O interfaces 922 are coupled to a communications network 938 and directly to a computing device 942. The computing device 942 is shown as a personal computer, but may be equally be practised using a smartphone, laptop, or a tablet device. Direct communication between the general purpose computer 910 and the computing device 942 may be implemented using a wireless or wired transmission link.

The communications network 938 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 910 is able to communicate via the communications network 938 to other computing devices connected to the communications network 938, such as the mobile telephone handset 944, the touchscreen smartphone 946, the personal computer 940, and the computing device 942.

One or more instances of the general purpose computer 910 may be utilised to implement a server 810 acting as a webhosting platform and trading platform to implement a property trading system in accordance with the present disclosure. In such an embodiment, the memory 914 and storage 916 are utilised to store data relating to listed properties, registered users, past trading statistics, market analysis, and the like. Software for implementing the property trading system is stored in one or both of the memory 914 and storage 916 for execution on the processor 912. The software includes computer program code for implementing method steps in accordance with the method of trading property described herein.

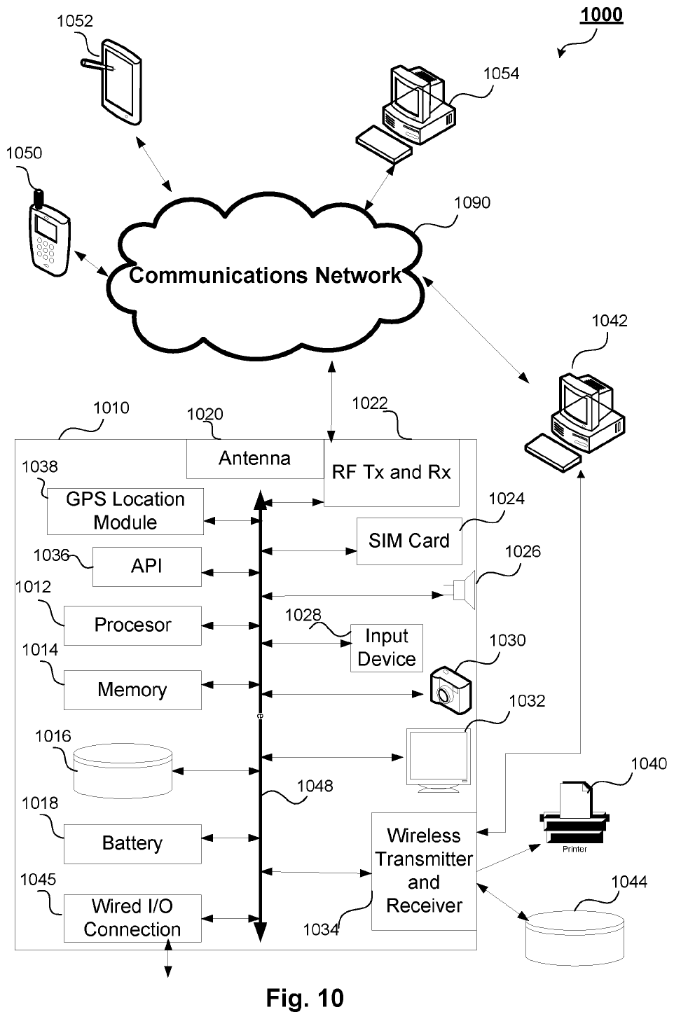

FIG. 10 is a schematic block diagram of a system 1000 on which one or more aspects of a property trading method and system of the present disclosure may be practised. The system 1000 includes a portable computing device in the form of a smartphone 1010, which may be used to implement one or more of the computing devices 810, 880, 850 accessed by a registered user 802, 885, 895 of the property trading system in FIG. 8. The smartphone 1010 includes a plurality of components, including: a processor 1012, a memory 1014, a storage medium 1016, a battery 1018, an antenna 1020, a radio frequency (RF) transmitter and receiver 1022, a subscriber identity module (SIM) card 1024, a speaker 1026, an input device 1028, a camera 1030, a display 1032, and a wireless transmitter and receiver 1034. Components of the smartphone 1010 generally communicate using one or more bus connections 1048 or other connections therebetween. The smartphone 1010 also includes a wired connection 1045 for coupling to a power outlet to recharge the battery 1018 or for connection to a computing device, such as the general purpose computer 910 of FIG. 9. The wired connection 1045 may include one or more connectors and may be adapted to enable uploading and downloading of content from and to the memory 1014 and SIM card 1024.

The smartphone 1010 may include many other functional components, such as an audio digital-to-analogue and analogue-to-digital converter and an amplifier, but those components are omitted for the purpose of clarity. However, such components would be readily known and understood by a person skilled in the relevant art.

The memory 1014 may include Random Access Memory (RAM), Read Only Memory (ROM), or a combination thereof. The storage medium 1016 may be implemented as one or more of a solid state “flash” drive, a removable storage medium, such as a Secure Digital (SD) or microSD card, or other storage means. The storage medium 1016 may be utilised to store one or more computer programs, including an operating system, software applications, and data. In one mode of operation, instructions from one or more computer programs stored in the storage medium 1016 are loaded into the memory 1014 via the bus 1048. Instructions loaded into the memory 1014 are then made available via the bus 1048 or other means for execution by the processor 1012 to implement a mode of operation in accordance with the executed instructions.

The smartphone 1010 also includes an application programming interface (API) module 1036, which enables programmers to write software applications to execute on the processor 1012. Such applications include a plurality of instructions that may be pre-installed in the memory 1014 or downloaded to the memory 1014 from an external source, via the RF transmitter and receiver 1022 operating in association with the antenna 1020 or via the wired connection 1045.

The smartphone 1010 further includes a Global Positioning System (GPS) location module 1038. The GPS location module 1038 is used to determine a geographical position of the smartphone 1010, based on GPS satellites, cellular telephone tower triangulation, or a combination thereof. The determined geographical position may then be made available to one or more programs or applications running on the processor 1012.

The wireless transmitter and receiver 1034 may be utilised to communicate wirelessly with external peripheral devices via Bluetooth, infrared, or other wireless protocol. In the example of FIG. 10, the smartphone 1010 is coupled to each of a printer 1040, an external storage medium 1044, and a computing device 1042. The computing device 1042 may be implemented, for example, using the general purpose computer 910 of FIG. 9.

The camera 1026 may include one or more still or video digital cameras adapted to capture and record to the memory 1014 or the SIM card 1024 still images or video images, or a combination thereof. The camera 1026 may include a lens system, a sensor unit, and a recording medium. A user of the smartphone 1010 may upload the recorded images to another computer device or peripheral device using the wireless transmitter and receiver 1034, the RF transmitter and receiver 1022, or the wired connection 1045.

In one example, the display device 1032 is implemented using a liquid crystal display (LCD) screen. The display 1032 is used to display content to a user of the smartphone 1010. The display 1032 may optionally be implemented using a touch screen, such as a capacitive touch screen or resistive touchscreen, to enable a user to provide input to the smartphone 1010.

The input device 1028 may be a keyboard, a stylus, or microphone, for example, for receiving input from a user. In the case in which the input device 1028 is a keyboard, the keyboard may be implemented as an arrangement of physical keys located on the smartphone 610. Alternatively, the keyboard may be a virtual keyboard displayed on the display device 1032.

The SIM card 1024 is utilised to store an International Mobile Subscriber Identity (IMSI) and a related key used to identify and authenticate the user on a cellular network to which the user has subscribed. The SIM card 1024 is generally a removable card that can be used interchangeably on different smartphone or cellular telephone devices. The SIM card 1024 can be used to store contacts associated with the user, including names and telephone numbers. The SIM card 1024 can also provide storage for pictures and videos. Alternatively, contacts can be stored on the memory 1014.

The RF transmitter and receiver 1022, in association with the antenna 1020, enable the exchange of information between the smartphone 1010 and other computing devices via a communications network 1090. In the example of FIG. 10, RF transmitter and receiver 1022 enable the smartphone 1010 to communicate via the communications network 1090 with a cellular telephone handset 1050, a smartphone or tablet device 1052, a computing device 1054 and the computing device 1042. The computing devices 1054 and 1042 are shown as personal computers, but each may be equally be practised using a smartphone, laptop, or a tablet device.

The communications network 1090 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

### INDUSTRIAL APPLICABILITY

The arrangements described are applicable to the property, investment, and finance industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A system for facilitating the sale of a portion of a property, the system including:
a database for storing property data relating to at least one property offered for conversion to shares and trading data relating to past property share trading activities, wherein each property is associated with a set of ordinary shares and related derivative instruments;
a trading platform adapted to provide an exchange for trading of shares and derivative instruments in said at least one property, based on said received trading requests; and
a computer server adapted to host a website associated with said trading platform, said website providing a user interface to receive trading requests in relation to said shares and derivative instruments.

2. The system according to claim 1, wherein said trading platform generates one or more market indices based on trading data relating to securities traded on said platform, said securities relating to shares and derivative instruments associated with properties listed on said trading platform.

3. The system according to claim 2, wherein said trading platform is associated with a user interface adapted for display on a display device of a computing device accessed by a user, said user interface including a dashboard for displaying at least one of said market indices.

4. The system according to claim 3, wherein said trading platform generates a market analysis report available for viewing on said dashboard of said user interface.

5. The system according to claim 3, wherein said user interface is adapted to receive from said user trading instructions for execution on said trading platform, said trading instructions relating to trading of at least one of shares and derivative instruments in said at least one property.

6. The system according to claim 1, further comprising:
a market analysis data module for storing pricing and conditional data; and
a title lease contract (TLC) processor adapted to generate a TLC in relation to a property listed on said trading platform, based on said pricing and conditional data.

7. The system according to claim 6, wherein said trading platform is further adapted to distribute proceeds derived from the title lease contract as dividends to holders of the ordinary shares relating to said property.

8. The system according to claim 7, wherein said dividends are calculated based on a period of time for which the ordinary shares relating to said property have been held.

9. The system according to claim 1, wherein said trading platform is further adapted to offer discounted share options, relating to one of said at least one property, to holders of said title lease contracts for said property.

10. The system according to claim 7, wherein a lease payment is payable by each holder of a title lease contract, each said lease payment being dependent on an amount of equity held in said property by said respective title lease contract holder.

11. A property trading method comprising the steps of:
receiving initial property information regarding a property;
determining an initial property valuation for said property, based on said initial property information;
converting said property to a set of securities and related derivative instruments; and
listing said set of securities and related derivative instruments for trading on a property trading platform.

12. The method according to claim 11,
wherein said set of securities includes ordinary securities.

13. The method according to claim 11, wherein said initial property valuation is further based on market data.

14. The method according to claim 11, wherein said property trading platform generates one or more market indices based on trading data relating to securities traded on said platform.

15. The method according to claim 11, wherein said property trading platform generates a market analysis report.

16. The method according to claim 11, comprising the further step of:
generating at least one title lease contract for said property.

17. The method according to claim 16, wherein said generating of said at least one title lease contract is based on relevant pricing and conditional data.

18. The method according to claim 16, wherein a lease payment is payable by each holder of a title lease contract, each said lease payment being dependent on an amount of equity held in said property by said respective title lease contract holder.

19. The method according to claim 16, comprising the further step of:
distributing proceeds derived from the title lease contract as dividends to holders of the ordinary shares relating to said property.

20. The method according to claim 19, comprising the further step of:
calculating said dividends based on a period of time for which the ordinary shares relating to said property have been held.

21. (canceled)

22. (canceled)
